(19) United States
(12) Patent Application Publication
(10) Pub. No.: US 2012/0199772 A1
(43) Pub. Date: Aug. 9, 2012

(54) SOLENOID VALVE FOR BRAKE SYSTEMS

(75) Inventors: Yong Kap Kim, Gyeonggi-do (KR); I Jin Yang, Gyeonggi-do (KR); Hyun Jun Kim, Gyeonggi-do (KR); Dong Yo Ryu, Seoul (KR); Jong Young Park, Seoul (KR)

(73) Assignee: MANDO CORPORATION

(21) Appl. No.: 13/364,011

(22) Filed: Feb. 1, 2012

(30) Foreign Application Priority Data
Feb. 1, 2011 (KR) 10-2011-0009859

(51) Int. Cl. F16K 31/02; F16K 1/00

(52) U.S. Cl. 251/129.15; 251/321

(57) ABSTRACT

Disclosed herein is a solenoid valve for brake systems which improves an assembly structure of components constituting the valve to enhance durability and control performance of the valve. The solenoid valve includes a sheet housing, a valve sheet, a sleeve, a magnetic core and an armature, the armature includes an upper body and a lower body separated from each other, the upper body is formed of a magnetic material and has an external diameter corresponding to the internal diameter of the sleeve so as to be guided and moved forward and backward within the sleeve, the lower body is formed of a non-magnetic material, is provided with an opening and closing part to open and close an orifice of the valve sheet, and elastic members to press the upper body and the lower body in the facing directions to move the upper body and the lower body together are provided.

### CROSS-REFERENCE TO RELATED APPLICATION

This application claims the benefit of Korean Patent Application No. 2011-0009859, filed on Feb. 1, 2011 in the Korean Intellectual Property Office, the disclosure of which is incorporated herein by reference.

### BACKGROUND

1. Field

Embodiments of the present invention relate to a solenoid valve for brake systems which improves an assembly structure of components constituting the valve to enhance durability and control performance of the valve.

2. Description of the Related Art

In general, a hydraulic brake of a vehicle executes braking by applying hydraulic pressure to a master cylinder through operation of a brake pedal. Here, if braking force which is greater than static frictional force between a road surface and a tire is applied, slippage of the tire on the road surface occurs.

However, a coefficient of kinetic friction is smaller than a coefficient of static friction, and thus in order to achieve optimal braking, such slippage needs to be prevented and handle locking in which control of a handle is difficult during operation of the brake needs to be prevented.

Therefore, an anti-lock brake system (ABS) which controls hydraulic pressure applied to a master cylinder to prevent the above problems has been proposed. The ABS basically includes a plurality of solenoid valves, an electronic control unit (ECU) to control the solenoid valves, an accumulator and a hydraulic pump.

These solenoid valves are classified into a normal open-type solenoid valve disposed upstream of the hydraulic brake and maintaining an opened state at normal times, and a normal close-type solenoid valve disposed downstream of the hydraulic brake and maintaining a closed state at normal times.

FIG. 1 is a longitudinal-sectional view illustrating a conventional normal close-type solenoid valve. Such a solenoid valve 10 is press-fit into a bore 15 of a modulator block 11 provided with channels of a brake system, and includes a hollow sheet housing 1 having an inlet 3 and an outlet 4 communicating with an inflow channel 13 and an outflow channel 14 of the modulator block 11 to enable a fluid to flow.

A valve sheet 8 having a hollow formed therein to communicate with the inlet 3 and the outlet 4 and provided with an orifice 8a formed at the upper end thereof is press-fit into the sheet housing 1.

Further, a cylindrical sleeve 6 is connected to the upper portion of the sheet housing 1 such that an armature 5 installed in the sheet housing 1 may move forward and backward, and a magnetic core 7 closing an opened end of the sleeve 6 and moving the armature 5 forward and backward is connected to the opened end of the sleeve 6.

The armature 5 is formed of a magnetic material, and moves forward and backward to open and close the orifice 8a of the valve sheet 8 installed within the sheet housing 1. For this purpose, the armature 5 is provided with an opening and closing part 5a extending toward the valve sheet 8 through a through hole 2 of the sheet housing 1.

A return spring 9 pressing the armature 5 to cause the armature 5 to close the orifice 8a at normal times is installed between the armature 5 and the magnetic core 7, and an exciting coil assembly (not shown) to move the armature 5 forward and backward is installed on the external surfaces of the sleeve 6 and the magnetic core 7.

In such a solenoid valve 10, when power is applied to the exciting coil assembly, magnetic force between the magnetic core 7 and the armature 5 occurs, and the armature 5 moves toward the magnetic core 7 due to such magnetic force to open the orifice 8a of the valve sheet 8. On the other hand, when power is not applied to the exciting coil assembly, magnetic force does not occur, and the armature 5 is returned to its original state by elasticity of the return spring 9 to close the orifice 8a.

When a magnetic field is generated in such a manner, the armature 5 moves toward the magnetic coil 7 and thus opens the orifice 8a of the valve sheet 8. When power is not applied to the exciting coil assembly, no magnetic field is generated and thus the armature 5 is operated to close the orifice 8a due to elasticity of the return spring 9.

The above-described solenoid valve 10 is configured to guide movement of the armature 5 using an interval G between the armature 5 and the sleeve 6 when the armature 5 is operated. That is, the armature 5 moves under guidance of the sleeve 6.

Such a solenoid valve 10 needs to assure operating durability due to frequent braking. In order to assure operating durability, shaking of the armature 5 when the armature 5 contacts the valve sheet 8 needs to be removed. In order to minimize such shaking, movement of the armature 5 around a region close to the valve sheet 8 needs to be stably guided.

However, in the conventional solenoid valve 10, movement of the armature 5 is guided only using the interval G between the armature 5 and the sleeve 6. That is, as shown in FIG. 1, since a gap S between the opening and closing part 5a formed at the lower end of the armature 5 and the sheet housing 1 is relatively large, the armature 5 is not stably guided and thus shaking of the armature 5 occurs.

Therefore, the gap S between the armature 5 and the sheet housing 1 is reduced to stably guide the armature 5. However, in this case, when power is applied to the exciting coil assembly, a flow of magnetic force through the reduced gap S between the armature 5 and the sheet housing 1 is generated, and thus responsiveness and controlled linearity of the solenoid valve 10 may be greatly lowered due to magnetic force change according to current change. That is, as shown in FIG. 2, magnetic force is nonlinearly changed according to current change and thus responsiveness and controlled linearity of the solenoid valve 10 are lowered.

### SUMMARY

Therefore, it is an aspect of the present invention to provide a solenoid valve for brake systems which reduces a gap between an armature and a sheet housing and thus stably moves the armature without shaking to improve operating durability and to assure responsiveness and controlled linearity of the solenoid valve.

Additional aspects of the invention will be set forth in part in the description which follows and, in part, will be obvious from the description, or may be learned by practice of the invention.

In accordance with one aspect of the present invention, a solenoid valve for brake systems includes a sheet housing installed within a bore of a modulator block and provided with a through hole formed therethrough in the lengthwise direction, a valve sheet installed within the through hole of the sheet housing and provided with an orifice, a sleeve provided with a hollow formed therein and connected to the sheet housing while surrounding the external surface of the upper portion of the sheet housing, a magnetic core to seal the upper portion of the sleeve, and an armature installed within the sleeve to be movable forward and backward, wherein the armature includes an upper body and a lower body separated from each other, the upper body is formed of a magnetic material and has an external diameter corresponding to the internal diameter of the sleeve so as to be guided and moved forward and backward within the sleeve, the lower body is formed of a non-magnetic material, is provided with an opening and closing part to open and close the orifice and has an external diameter corresponding to the diameter of the through hole so as to be guided and moved forward and backward within the sheet housing, and elastic members to press the upper body and the lower body in the facing directions to move the upper body and the lower body of the armature together are provided.

The elastic members may include a first return spring installed between the magnetic core and the upper body and pressing the upper body toward the lower body to enable the opening and closing part to close the orifice, and a second return spring installed between the lower body and the valve sheet and pressing the lower body toward the upper body to maintain the contact state of the lower body with the upper body.

The elastic force of the first return spring may be greater than the elastic force of the second return spring.

A spring support part to support one end of the second return spring may be provided on the valve sheet around the orifice, and a spring support protrusion having a stepped shape to support the other end of the second return spring may be provided on the lower surface of the lower body around the opening and closing part.

At least one slot-shaped oil channel through which oil flows in the vertical direction may be formed along the external surface of the lower body.

Stepped parts symmetrical to each other may be respectively provided on the upper surface of the upper body and the lower surface of the magnetic core such that the stepped part of the upper body and the stepped part of the magnetic core are engaged with each other.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a longitudinal-sectional view illustrating a conventional solenoid valve;

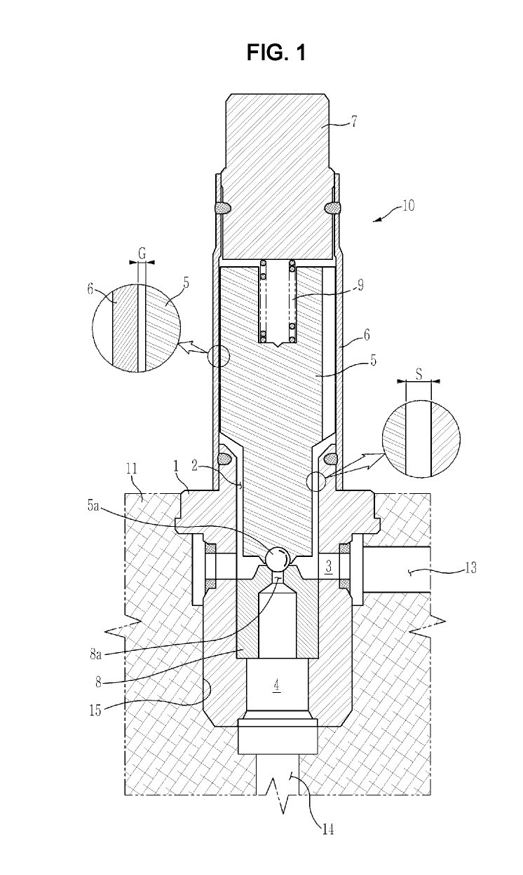

FIG. 2 is a graph illustrating magnetic force change of the conventional solenoid valve according to current change;

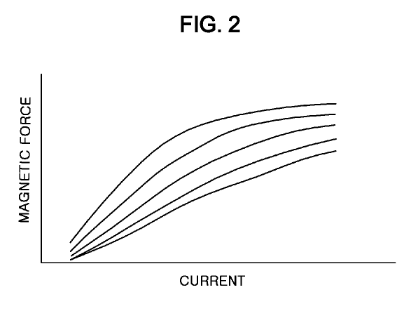

FIG. 3 is a longitudinal-sectional view illustrating a solenoid valve for brake systems in accordance with one embodiment of the present invention;

FIG. 4 is a longitudinal-sectional view illustrating the solenoid valve for brake systems in accordance with the embodiment of the present invention in a state in which an orifice is opened; and

FIG. 5 is a graph illustrating magnetic force change of the solenoid valve for brake systems in accordance with the embodiment of the present invention according to current change.

### DETAILED DESCRIPTION

Reference will now be made in detail to the embodiments of the present invention, examples of which are illustrated in the accompanying drawings, wherein like reference numerals refer to like elements throughout. The terms used in the following description are terms defined taking into consideration the functions obtained in accordance with the embodiments, and the definitions of these terms should be determined based on the whole content of this specification. The configurations disclosed in the embodiments and the drawings of the present invention are only exemplary and do not include all of the technical spirit of the invention, and thus it will be appreciated that the embodiments may be variously modified and changed.

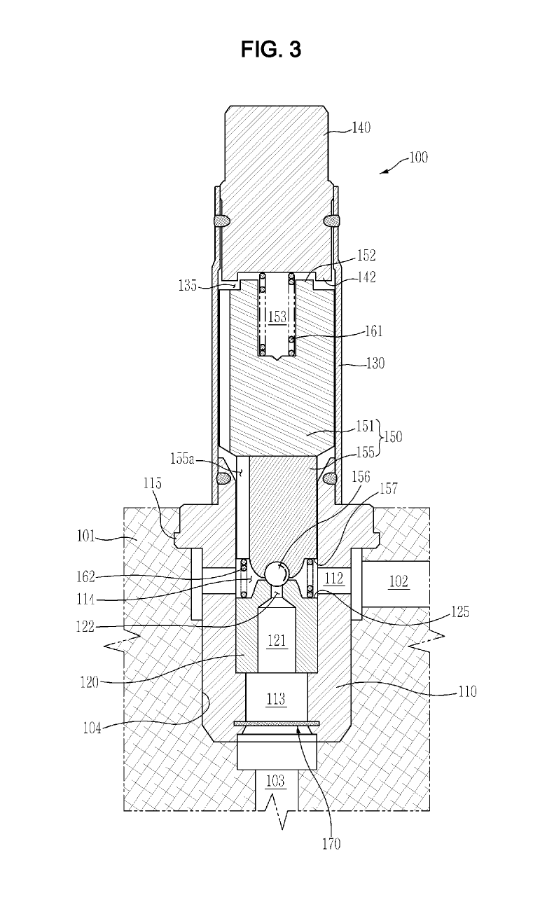

FIG. 3 is a longitudinal-sectional view illustrating a solenoid valve for brake systems in accordance with one embodiment of the present invention.

With reference to FIG. 3, a solenoid valve 100 for brake systems in accordance with this embodiment includes a sheet housing 110 inserted into a modulator block 101, a valve sheet 120 installed within the sheet housing 110, a sleeve 130 provided with one end connected to the sheet housing 110, a magnetic core 140 connected to the other end of the sleeve 130 opposite to the sheet housing 110, and an armature 150 moving forward and backward within the sleeve 130.

The sheet housing 110 has a cylindrical shape provided with a through hole 114 formed through the center thereof in the lengthwise direction. A flange part 115 to fix the sheet housing 110 to an inlet of a bore 104 of the modulator block 101 is provided on the external surface of the sheet housing 110. The flange part 115 is fixed by deformation of the modulator block 101 when the valve 100 is installed.

The sheet housing 110 is provided with an inlet 112 and an outlet 113 respectively communicating with the through hole 114, an inflow channel 102 and an outflow channel 103 formed on the modulator block 101 through which oil is introduced into and discharged from the sheet housing 110.

The valve sheet 120 is fixed to the inside of the through hole 114 of the sheet housing 110 by press-fit. The valve sheet 120 is provided with an inner channel 121 passing through the valve sheet 120 in the lengthwise direction and an orifice 122 formed at the upper end of the inner channel 121 to open and close the inner channel 121.

The sleeve 130 has a cylindrical shape such that the armature 150 installed within a hollow 135 of the sleeve 130 may move forward and backward, and upper and lower portions of the sleeve 130 are opened. The opened lower portion of the sleeve 130 is fixed to the external surface of the upper portion of the sheet housing 110 by press-fit. Such a sleeve 130 may be fixed to the sheet housing 110 through welding, etc.

The magnetic core 140 closing the opened upper portion of the sleeve 130 and generating electromagnetic force to move the armature 150 forward and backward is connected to the opened upper portion of the sleeve 130. Here, in order to generate such electromagnetic force, an exciting coil assembly (not shown) generating a magnetic field by application of power is installed on the external surfaces of the magnetic core 140 and the sleeve 130. When power is applied to the exciting coil assembly, the armature 150 moves toward the magnetic core 140.

A first return spring 161 is installed between the armature 150 and the magnetic core 140 so that, when power applied to the exciting coil assembly is interrupted, the armature 150 is returned to its original position to close the orifice 122 of the valve sheet 120. The first return spring 161 will be described in detail later.

In accordance with the embodiment of the present invention, the armature 150 opens and closes the orifice 122 of the valve sheet 120 through forward and backward movement, as described above. In more detail, the armature 150 includes an upper body 151 provided within the sleeve 130 and moving forward and backward, and a lower body 155 inserted into the through hole 114 of the sheet housing 110 and moving forward and backward.

The upper body 151 is formed of a magnetic material, and has an external diameter corresponding to the internal diameter of the sleeve 130 so as to be guided within the hollow 135 of the sleeve 130. Here, the external diameter of the upper body 151 may be smaller than the internal diameter of the sleeve 130 by a fine interval.

The lower body 155 is formed of a non-magnetic material, and has an external diameter corresponding to the diameter of the through hole 114 of the sheet housing 110 so as to be guided within the sheet housing 110. Here, the external diameter of the lower body 155 may be smaller than the diameter of the through hole 114 by a fine interval. A sphere-shaped opening and closing part 156 to open and close the orifice 122 is provided at the lower end of the lower body 155, and a slot-shaped oil channel 155a through which oil flows in the vertical direction to effectively move the armature 150 is formed on the external surface of the lower body 155.

Since the lower body 155 in accordance with the embodiment of the present invention is formed of a non-magnetic material, lowering of responsiveness of the solenoid valve 100 which may be generated due to the reduced gap with the sheet housing 110 may be avoided.

Further, since the upper body 151 is guided and moved within the sleeve 130 and the lower body 155 is guided and moved within the sheet housing 110, the armature 150 is stably moved without shaking and thus operating durability is improved.

In accordance with the embodiment of the present invention, the solenoid valve 100 further includes elastic members pressing the upper body 151 and the lower body 155, separated from each other, in the facing directions.

The elastic members include the first return spring 161 pressing the upper body 151 toward the lower body 155 and a second return spring 162 pressing the lower body 155 toward the upper body 151, so as to move the upper body 151 and the lower body 155 together.

The first return spring 161 is installed between the upper body 151 and the magnetic core 140 and presses the upper body 151 toward the lower body 155, thereby enabling the lower body 155 to close the orifice 122 of the valve sheet 120.

The second return spring 162 is installed between the lower body 155 and the valve sheet 120 and presses the lower body 155 toward the upper body 151, thereby serving to maintain the contact state of the lower body 155 with the upper body 151. Here, the elastic force of the first return spring 161 is greater than the elastic force of the second return spring 162 so that, when magnetic force is not generated, the opening and closing part 156 of the lower body 155 closes the orifice 122 of the valve sheet 120 to close a fluid channel.

The upper body 151 and the lower body 155 move together under the condition that the contact state of the lower body 155 with the upper body 151 is maintained by the first return spring 161 and the second return spring 162. Further, since the lower body 155 moves upward by the second return spring 162, the fluid channel requires only slight force to be opened. Moreover, since the upper body 151 and the lower body 155 are not integrated but are separated, only force on the contact surface between the upper body 151 and the lower body 155 may be effectively transmitted regardless of influence of shaking of counterpart components.

Non-described reference numeral 153 represents a spring insertion groove which is formed on the upper body 151 so that the first return spring 161 may be stably installed within the upper body 151.

In order to stably install the second return spring 162, a spring support part 125 to support one end of the second return spring 162 is provided on the valve sheet 120 around the orifice 122, and a spring support protrusion 157 having a stepped shape to support the other end of the second return spring 162 is provided on the lower surface of the lower body 155 around the opening and closing part 156. Thereby, the second return spring 162 is stably installed without interference with the opening and closing operation of the orifice 122 by the lower body 155.

In accordance with the embodiment of the present invention, stepped parts 152 and 142 symmetrical to each other are respectively provided on the upper surface of the upper body 151 and the lower surface of the magnetic core 140 to restrict a forward and backward movement distance of the upper body 151 when the upper body 151 is moved by the magnetic field. That is, the stepped part 152 of the upper body 151 and the stepped part 142 of the magnetic core 140 are configured to be engaged with each other.

Additionally, as shown in FIG. 3, a filter member 170 is installed at the outlet 113 of the sheet housing 110 so as to filter out impurities from oil discharged through the outflow channel 103 of the modulator block 101. Although the embodiment illustrates the filter member 170 as being installed only at the outlet 113 of the sheet housing 110, the position of the filter member 170 is not limited thereto. That is, the filter member 170 may be installed at the inlet 112 of the sheet housing 110 so as to filter out impurities from oil introduced through the inflow channel 102 of the modulator block 101.

Hereinafter, operation of the above-described solenoid valve 100 will be described.

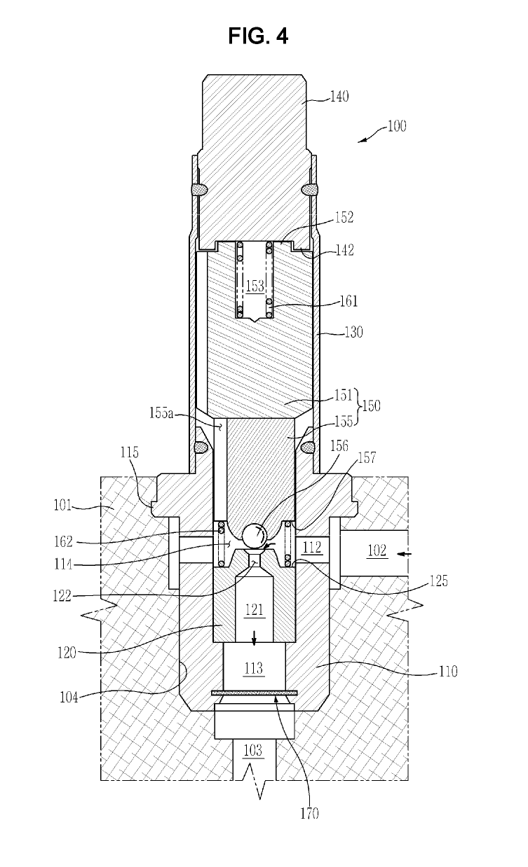

First, when power is applied to the exciting coil assembly (not shown) provided on the external surfaces of the magnetic core 140 and the sleeve 130, a magnetic field is formed and the upper body 151 moves upward against the elastic force of the first return spring 161. At this time, the lower body 155 contacting the lower surface of the upper body 151 moves upward together with the upper body 151. That is, the upper body 151 and the lower body 155 move upward under the condition that the lower body 155 contacts the upper body 151 by the second return spring 162 installed between the lower body 155 and the valve sheet 120, as shown in FIG. 4, and thus the orifice 122 is opened. Thereby, introduced oil flows from the inflow channel 102 to the outflow channel 103 via the orifice 122.

Then, when power applied to the exciting coil assembly is interrupted, the magnetic field is removed, the upper body 151 and the lower body 155 move downward due to elastic force of the first return spring 161, and thus the opening and closing part 156 formed at the lower end of the lower body 155 closes the orifice 122 of the valve sheet 120. The reason for this is that the elastic force of the first return spring 161 is greater than the elastic force of the second return spring 162.

When such operation is carried out, the upper body 151 is stably guided and moved through the gap between the upper body 151 and the sleeve 130, and the lower body 155 is stably guided and moved through the gap between the lower body 155 and the sheet housing 110. Thereby, the armature 150 is stably moved forward and backward while minimizing shaking of the armature 150, thus improving operating durability. Further, the lower body 155 is formed of a non-magnetic material and is not influenced by change of the magnetic field, thereby assuring responsiveness and controlled linearity of the solenoid valve 100.

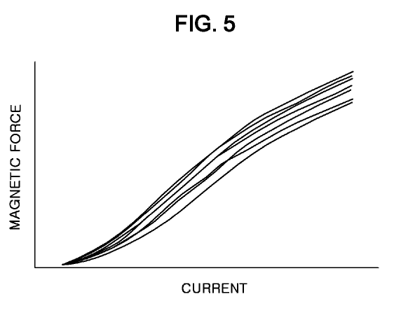

Consequently, in the solenoid valve 100 in accordance with the embodiment of the present invention, as shown in FIG. 5, magnetic force is linearly changed according to change of current applied to the exciting coil assembly. When the magnetic force is linearly changed in such a manner, the solenoid valve 100 may be easily controlled as compared to the conventional solenoid valve. Further, magnetic force is not changed according to reduction of the gap between the lower body 155 and the sheet housing 110, and performance of the solenoid valve 100 is stably assured through movement of the armature 150 while minimizing shaking.

As is apparent from the above description, in a solenoid valve for brake systems in accordance with one embodiment of the present invention, a lower body of an armature is formed of a non-magnetic material and magnetic force is not changed even if a gap between the lower body and a sheet housing is reduced, thereby preventing lowering of responsiveness of the solenoid valve and assuring controlled linearity of the solenoid valve. Therefore, the armature contacts a valve sheet while minimizing shaking of the armature, thus operating durability of the solenoid valve.

Further, the armature is divided into upper and lower bodies and the upper and lower bodies are elastically pressed toward each other so as to maintain a contact state between the upper and lower bodies, thereby effectively transmitting only force on the contact surface between the upper and lower bodies regardless of influence of shaking of counterpart components.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A solenoid valve for brake systems comprising a sheet housing installed within a bore of a modulator block and provided with a through hole formed therethrough in the lengthwise direction, a valve sheet installed within the through hole of the sheet housing and provided with an orifice, a sleeve provided with a hollow formed therein and connected to the sheet housing while surrounding the external surface of the upper portion of the sheet housing, a magnetic core to seal the upper portion of the sleeve, and an armature installed within the sleeve to be movable forward and backward, wherein:
the armature includes an upper body and a lower body separated from each other;
the upper body is formed of a magnetic material and has an external diameter corresponding to the internal diameter of the sleeve so as to be guided and moved forward and backward within the sleeve;
the lower body is formed of a non-magnetic material, is provided with an opening and closing part to open and close the orifice and has an external diameter corresponding to the diameter of the through hole so as to be guided and moved forward and backward within the sheet housing; and
elastic members to press the upper body and the lower body in the facing directions to move the upper body and the lower body of the armature together are provided.

2. The solenoid valve for brake systems according to claim 1, wherein the elastic members include:
a first return spring installed between the magnetic core and the upper body and pressing the upper body toward the lower body to enable the opening and closing part to close the orifice; and
a second return spring installed between the lower body and the valve sheet and pressing the lower body toward the upper body to maintain the contact state of the lower body with the upper body.

3. The solenoid valve for brake systems according to claim 2, wherein the elastic force of the first return spring is greater than the elastic force of the second return spring.

4. The solenoid valve for brake systems according to claim 2, wherein a spring support part to support one end of the second return spring is provided on the valve sheet around the orifice, and a spring support protrusion having a stepped shape to support the other end of the second return spring is provided on the lower surface of the lower body around the opening and closing part.

5. The solenoid valve for brake systems according to claim 1, wherein at least one slot-shaped oil channel through which oil flows in the vertical direction is formed along the external surface of the lower body.

6. The solenoid valve for brake systems according to claim 1, wherein stepped parts symmetrical to each other are respectively provided on the upper surface of the upper body and the lower surface of the magnetic core such that the stepped part of the upper body and the stepped part of the magnetic core are engaged with each other.
